(19) United States
(12) Patent Application Publication
(10) Pub. No.: US 2002/0163160 A1
(43) Pub. Date: Nov. 7, 2002

(54) Motorcycle kickstand pad

(76) Inventor: Russ Golemba, Rockford, MI (US)

Correspondence Address: Warner Norcross & Judd LLP, Intellectual Property Practice Group, 900 Fifth Third Center, 111 Lyon Street, N.W., Grand Rapids, MI, 49503-2487, US

(21) Appl. No.: 10/138,155

(22) Filed: May 2, 2002

Related U.S. Application Data
(60) Provisional application No. 60/288,389, filed on May 3, 2001.

(51) Int. Cl. B62J 1/00

(52) U.S. Cl. 280/301

(57) ABSTRACT

A kickstand support pad for use as a stable surface between a motorcycle kickstand and soft or unstable terrain. The kickstand pad defines a groove into which the end of the kickstand is placed and held in position. The groove locates the kickstand to prevent it from sliding off the pad and also locates the kickstand in the optimal position for the kickstand pad to provide a stable surface. A tether may be attached to allow the user to attach the kickstand pad to the motorcycle and also pick up the kickstand pad without bending over. A relief pocket is provided to ensure the kickstand pad does not rest on the means used to attach the tether to the kickstand pad.

### PRIORITY

This application claims priority from Provisional Patent Application No. 60/288,389 filed May 3, 2001, entitled “MOTORCYCLE KICKSTAND PAD”

### BACKGROUND OF THE INVENTION

1. Field of the Invention

The present invention relates to motorcycle accessories, and more particularly to kickstand pads.

2. Description of the Art

The riding of motorcycles is a popular means of transportation and recreation. Motorcycles have and continue to increase in sophistication, cost, and popularity. When parked, motorcycles are supported in an upright position by a kickstand. A kickstand for a motorcycle must provide a stable support to prevent the motorcycle from tipping over and causing damage to the motorcycle or nearby objects.

Motorcycles are used outdoors and upon arrival at a destination are parked on a variety of materials such as asphalt, cement, sand, dirt or grass. Many of these surfaces fail to provide the necessary support for a kickstand preventing the motorcycle from staying in an upright position. The kickstand may gradually sink into the surface until the motorcycle tilts to an angle great enough to cause it to tip over. Some surfaces that are normally stable may also cause motorcycles to tip, for example, a kickstand may sink into asphalt on a hot day, damaging the cycle and potentially nearby vehicles. The damages caused by and to the motorcycles cost insurance companies substantial amounts of money each year.

To prevent motorcycles from tipping over, a rider many times will use any available materials to provide a more stable support under the kickstand. Space is limited on a motorcycle, therefore these materials are many times found at the destination. Examples of these materials may include newspapers, crushed cans, pieces of wood, magazines, tennis shoes or even the rider's helmet. Some bikers use flat pieces of metal to provide a more stable base as may be seen in U.S. Pat. No. 4,521,031 to Huth. The kickstand pad as shown in Huth only provides a larger surface area for the kickstand to rest on. The kickstand pad in Huth is also difficult to place under the kickstand while parking the motorcycle and difficult to pick up from under the kickstand as the rider prepares to leave. The rider must get off the motorcycle, take out the kickstand pad, put down the kickstand, and attempt to position the kickstand in the middle of the kickstand pad. When leaving, the rider must hold the motorcycle upright while bending over to remove and pick up the kickstand pad. Many times these awkward procedures to place or remove the kickstand pad causes the motorcycle to tip over because the rider is off balance while removing or replacing the kickstand pad. If the motorcycle tips over while the rider is placing or removing the kickstand pad, the motorcycle may cause injury to the rider. As more riders of motorcycles age, bending over to pick up the kickstand pad while holding onto the motorcycle is increasingly difficult to perform without causing back strain or other injuries.

One method of solving the problem of placing the kickstand pad under the kickstand is disclosed in U.S. Pat. No. 4,819,957 to Printy, which discloses a foldable handle attached to a flat kickstand pad. This handle is bulky and time consuming to operate even though it allows the user to pick up the kickstand pad without bending over. Yet another example of a kickstand pad may be found in U.S. Pat. No. 4,625,987 to Marsh et al which uses a flat pad with a chain attached by a bolt to the kickstand pad and the other end attached to one of the foot pegs. The user must still bend down to grab the chain. The bolt attaching the chain to the kickstand pad may cause the kickstand pad to be unstable and wobble. This prevents the kickstand pad from providing a stable supportive surface for the kickstand. The combination of the chain and kickstand pad are also heavy and bulky to store on a motorcycle where space is limited.

Another problem with kickstand pads is that they allow the kickstand to slide off the pad if the pad tilts or moves on soft or rocky ground. One device that attempts to prevent the kickstand from sliding off the pad while providing a solid base may be found in U.S. Pat. No. 4,474,387 to Maranell et al. Maranell discloses a flat base on which a somewhat oval wall rests with spikes on the bottom of the kickstand pad. The kickstand is held in place on the pad, and the pad is prevented from moving. This pad is also problematic. First, most parking lot owners do not want anyone using damaging spikes on the parking lot. Second, some motorcycles may have a kickstand with a base that is too long or an odd shape that is unable to fit within the oval. Third, the kickstand pad is bulky and difficult to carry, especially because the sharp spikes and tall oval wall make it hard to store safely on a motorcycle. Further, the size of the pad also makes it difficult to carry on a motorcycle, especially if the motorcycle does not have any storage bags or compartments.

### SUMMARY OF THE INVENTION

The aforementioned problems are overcome by the present invention comprising a kickstand pad that securely locates and places the kickstand while providing a large surface area to prevent the kickstand from sinking into the ground. In a preferred embodiment, the kickstand pad is made out of lightweight aluminum without any sharp corners or edges. In a more preferred embodiment, the kickstand pad includes a recessed V-groove to locate and hold the kickstand. The kickstand pad is sized and shaped to minimize the amount of space it takes up during transportation on the motorcycle while yet providing a large enough surface area to prevent the kickstand from sinking into the ground, and thereby prevent the motorcycle from tipping.

An optional reminder cord may attach to the kickstand pad and be clipped to the motorcycle to allow the rider to easily retrieve the pad without bending over. This alleviates back stress and eliminates the problem of the motorcycle tipping over while the rider is retrieving the pad. The pad also includes a relief pocket to allow the pad to sit flat on the ground without the kickstand or pad rocking or moving while the kickstand is placed on the pad.

These and other objects of the invention will be more fully understood and appreciated by reference to the detailed description of the preferred embodiments and the drawings.

### BRIEF DESCRIPTION OF THE DRAWINGS

FIG. 1 shows a perspective view of the kickstand pad and a kickstand supporting a motorcycle drawn in phantom lines;

FIG. 2 is a top view of the kickstand pad; FIG. 3 is a cross section of the pad in FIG. 2 at line 3-3; and

FIG. 4 is a perspective view of a kickstand pad attached to a reminder cord, the cord broken to show indeterminate length.

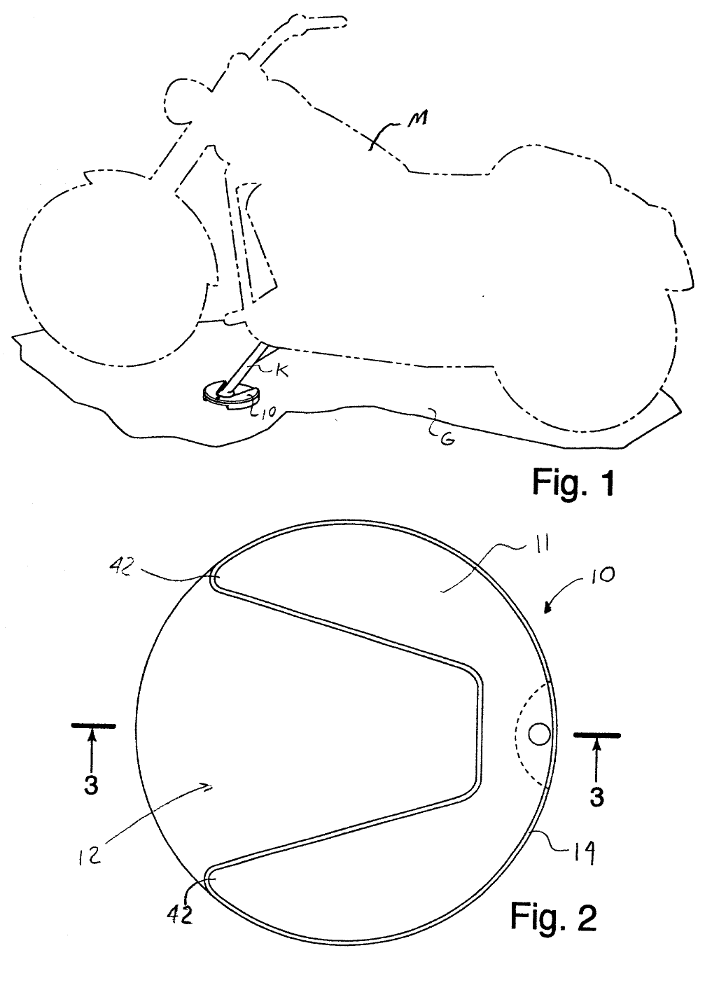

### DETAILED DESCRIPTION OF THE PREFERRED EMBODIMENT

The present invention provides a kickstand pad 10 that securely holds a motorcycle kickstand K to prevent the motorcycle M from tipping over. The kickstand pad 10 generally defines a groove 12, a chamfer 14, a relief pocket 18 and a hole 16.

Construction

The groove 12 is somewhat a V or U shape, as can be seen in FIG. 2. The groove 12 is defined on the top side 11 of the kickstand pad 10. The groove 12 includes a base wall 32 and sidewalls 34a and 34b. In the preferred embodiment, these walls 32, 34a and 34b define a chamfer 14, which helps place the kickstand K within the groove 12. In the preferred embodiment, these walls 32, 34a and 34b include both the chamfer 14 and a straight wall 15. The chamfer 14 is generally sloped at about a 45° angle, although other angles may readily be used. The base wall 32 and the sidewalls 34a and 34b may alternatively be formed without the chamfer to help keep the kickstand K located in the groove 12 of the kickstand pad 10. In the preferred embodiment, the base wall 32 and sidewalls 34a and 34b are about a quarter inch thick to allow the kickstand pad 10 to hold the kickstand K securely on the pad 10. Of course, other any other thickness of the base wall 32 and sidewalls 34a and 34b may readily be used. The size of the groove 12 may vary substantially depending on the size of the pad and the size of the kickstand K. In the preferred embodiment, the V groove 12 is sized and shaped to securely hold the majority of the kickstands K on motorcycles M, as shown in FIG. 2.

The kickstand pad 10 is shown in FIG. 2 as having a somewhat circular shape. It should be readily recognized that other shapes such as rectangles, squares, octagons and hexagons or any other shape may readily be used to securely hold the kickstand K while providing a stable base.

The kickstand pad 10 further defines a release pocket 18 and a hole 16. In the preferred embodiment, the relief pocket 18 and hole 16 are located near the bottom sidewall 32 of the groove 12. The relief pocket 18 is located on the bottom side 13 of kickstand pad 10. In the preferred embodiment, the hole 16 is centered approximately over the relief pocket 18. In an even more preferred embodiment, the hole 16 is located approximately ¾ an inch beyond the bottom sidewall 32 of the groove 12. Of course it should be readily apparent that the hole 16 and the relief pocket 18 may be located almost anywhere on the pad 10.

In the preferred embodiment, the outer sidewalls 40 include a chamfer 14 near the top side of the kickstand pad 10, as shown in FIGS. 2 and 3. The kickstand pad 10 may also include a chamfer (not shown) around the bottom perimeter of the outer sidewalls 40. Also in the preferred embodiment, the edges 42 where the sidewalls 34a and 34b of the groove 12 meet the outer sidewalls 40 may be rounded to eliminate any sharp points.

In the preferred embodiment, the kickstand pad 10 is sized to be easily stored, for example in a shirt pocket. In an even more preferred embodiment, the kickstand pad 10 is sized to have a diameter of less than five inches. In yet an even more preferred embodiment, the kickstand pad 10 is sized to have a diameter of less than four inches.

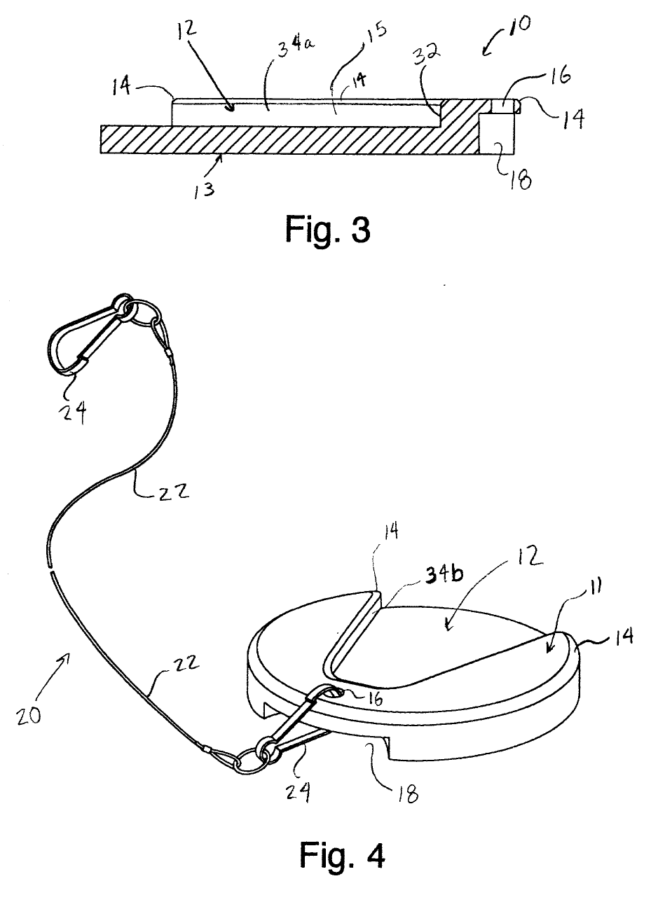

In an alternative embodiment, the kickstand pad 10 may include a cord kit 20, which allows a cable 22 to attach to the kickstand pad 10. The cord kit 20 generally includes a cable 22 and at least one hook 24. The cable 22 is preferably made out of plastic coated braided steel. Of course the cable may be readily made out of other materials such as plastic, string, nylon fibers, steel or even plastic or metal chain links. The cable 22 is well known in the industry and crimped over on itself at both ends providing the loops. The cable 22 may be looped through the hole 16 to permanently attach to the pad 10 or more preferably a snap hook 24 attach to the kickstand pad 10 through the hole 16 as shown in FIG. 4.

The kickstand pad 10 may also include large flat areas to allow a user or seller to customize the pad for the addition of logos.

Manufacture and Use

The kickstand pad 10 is manufactured using generally conventional machinery. In the preferred embodiment, the kickstand pad 10 is machined out of a block of aluminum with a CNC Mill. The CNC mill cuts out the groove, relief pocket 18, chamfer 14 and hole 16 from an aluminum block (not shown). The method of using a CNC machine to mill a solid block of aluminum is well known in the art. Of course it should be readily apparent that other machinery and techniques such as molding may also be used. The cord kit 20 may also be manufactured using conventional techniques and materials. In the preferred embodiment, a roll of braided steel that is plastic coated is cut to the proper length. The ends of the cord 22 fold over in loops and are crimped together. Of course the cord 22 may be bought from a third party already premanufactured to be attached to the kickstand pad 10. Any logos desired to be added may be CNC'd during the milling operation or etched in later. The kickstand pad 10 may also be anodized in a variety of colors to protect the aluminum and customize the kickstand pad 10 to the user's preferences.

To use the kickstand pad 10, the user clips the cord kit 20 using the snap hooks 24 to the hole 16. Because the relief pocket 18 is centered under the hole 16, when the cord kit 20 is attached to the kickstand pad 10, the kickstand pad 10 may still rest flat on the ground. This also allows the cord kit 20 to have movement while the user attaches it to the motorcycle without moving the kickstand pad 10 on the ground. The relief pocket 18 also prevents the snap hooks 24 or any other means of attaching the cord kit 20 to the kickstand pad 10 from causing the kickstand pad 10 from rocking on the ground due to an unstable base from any protrusion beyond the plane of the base 13. Once the kickstand pad 10 is placed on the ground, the rider lowers the kickstand K on the motorcycle M and rests it within the groove 12. In the preferred embodiment, the walls 32, 34a and 34b being in a combination of a U and a V shape allow the kickstand K to slide into the groove 12 to the point where it wedges itself against the walls 34a, 34b and 32 so that it does not slip off the kickstand pad 10. To remove the kickstand pad 10, the user simply tilts the motorcycle M upright, places the kickstand K in the retracted position and grabs the cord 22 to pull it off the ground without bending over. This prevents the motorcycle M from accidentally tipping over while the user is trying to retrieve the kickstand pad 10. The kickstand pad 10, after use is stored on the motorcycle or in a pocket of the rider.

The above description is that of a preferred embodiment of the invention. Various alterations and changes can be made without departing from the spirit and broader aspects of the invention as defined in the appended claims, which are to be interpreted in accordance with the principals of patent law including the doctrine of equivalents.

The embodiments of the invention in which an exclusive property or privilege is claimed are defined as follows:

1- A kickstand pad comprising:
a top side defining a groove and a base side defining a relief pocket; wherein said kickstand pad defines a hole between said top side and said relief pocket.

2- The kickstand pad of claim 1 wherein said groove includes a wall arranged in a U-shape.

3- The kickstand pad of claim 2 wherein said wall further comprises a pair of sidewalls and a base wall, said sidewalls being spaced closer together near said base wall than any other point along said sidewalls.

4- The kickstand pad of claim 3 wherein said groove includes a planar surface, said planar surface being located between said outer circumference, said base wall and said sidewalls.

5- The kickstand pad of claim 1 wherein said pad is somewhat of a circular shape, said pad including an outer circumference, said outer circumference including a chamfer.

6- The kickstand pad of claim 5 wherein said base and said outer circumference define said relief pocket.

7- The kickstand pad of claim 6 wherein said wall includes a midpoint, said relief pocket being located near said midpoint.

8- The kickstand pad of claim 1 wherein said kickstand pad has a diameter of less than five inches.

9- The kickstand pad of claim 1 wherein said kickstand pad has a diameter of less than 4.5 inches.

10- The kickstand pad of claim 1 wherein said kickstand pad has a diameter of less than 4.25 inches.

11- A kickstand pad designed for providing a stable surface on soft or normally unstable ground for parking a motorcycle using the kickstand, said kickstand pad comprising a disc having a first planar surface adapted to rest on the ground; a second planar surface; and a third planar surface; and a wall extending between said second planar surface and said third planar surface to define a recess, said recess unbounded by said wall in an area so that the kickstand slides into the recess adapted to receive and hold the kickstand.

12- The kickstand pad of claim 11 wherein said disc has a diameter of less than 4.5 inches.

13- The kickstand pad of claim 12 wherein said disc has a diameter of less than four inches.

14- The kickstand pad of claim 11 wherein said disc includes an outer circumference, said outer circumference have a distance of less than 14 inches.

15- A kickstand support adapted to support a kickstand on soft terrain comprising:
a pad including an outer circumference, a center and at least on radius of a first length extending from said center to said outer circumference, said pad defining a slot of a second length, said second length at least equal to said first length.

16- The kickstand support of claim 15 wherein said pad includes a base having a planar surface.

17- The kickstand support of claim 16 wherein said base and said outer circumference define a relief pocket, said relief pocket defining a hole.

18- The kickstand support of claim 17 further comprising a metallic tether attached to said hole.

19- The kickstand support of claim 18 wherein said metallic tether is attached to said hole by a snap hook.

20- The kickstand support of claim 15 wherein said pad includes a top surface, said top surface and said outer circumference defining said slot.

21- The kickstand support of claim 15 wherein said pad has a radius greater than 1.5 inches.

22- The kickstand support of claim 15 wherein said pad has a radius less than 2.25 inches.

23- The kickstand support of claim 15 wherein said pad has a radius less than 2 inches.

24- The kickstand support of claim 15 wherein said outer circumference has a length less than 16 inches.

25- The kickstand support of claim 15 wherein said outer circumference has a length less than 14 inches.

26- The kickstand support of claim 15 wherein said outer circumference has a length less than 12.75 inches.

27- A pad for maintaining motorcycles having a kickstand in an upright position on soft or unstable surfaces comprising:
an upper surface disposed at a first level and defining a groove, said groove including a planar surface disposed at a second level below said first level; wherein said groove is adapted to trap and locate the kickstand, said planar surface being adapted to support the kickstand.

28- The pad of claim 27 further comprising an outer circumference, said lower surface and said outer circumference defining a relief pocket.

29- The pad of claim 27 wherein said pad has a diameter of less than 4.25 inches.

30- The pad of claim 27 wherein said pad includes an outer circumference having a length less than 13 inches.
